(19) United States
(12) Patent Application Publication
(10) Pub. No.: US 2026/0152043 A1
(43) Pub. Date: Jun. 4, 2026

(54) ACTUATORS FOR ELECTRIC AIR VENTS IN AUTOMOBILES

(71) Applicant: NIFCO KOREA INC., Asan-si (KR)

(72) Inventor: Geun Heung KIM, Asan-si (KR)

(73) Assignee: NIFCO KOREA INC., Asan-si (KR)

(21) Appl. No.: 19/113,149

(22) PCT Filed: Sep. 13, 2023
(86) PCT No.: PCT/KR2023/013682

§ 371 Date: Feb. 16, 2026

(30) Foreign Application Priority Data
Sep. 20, 2022 (KR) 10-2022-0118615

(51) Int. Cl. B60H 1/34

(52) U.S. Cl. CPC B60H 1/3414; B60H 2001/3471

(57) ABSTRACT

The present invention relates to actuators for electric air vents in automobiles, and more specifically, even when an external force is applied to an operation knob, a gear part and a motor are prevented from being deformed or damaged by the external force applied to the operation knob.

The present invention is achieved by comprising: a forward/reverse motor (100) that, by a signal outputted from a control device (500), generates a driving force so as to rotate a shaft (600) in a forward/reverse direction; an input gear (110) formed in one direction and the other direction according to the rotation direction of the shaft (600) which rotates according to the driving force generated by the forward/reverse motor (100); a reduction gear part (200) that receives rotational force transmitted through the input gear (110) and rotates in one direction and the other direction; and a slip gear part (300) that receives rotational force transmitted through the reduction gear part (200) and rotates in one direction and the other direction, wherein the slip gear part (300) comprises a slip housing (310) in which a first coupling groove (311) and a second coupling groove (312) are formed on left and right sides so as to communicate, and which has serrated teeth (313) that engage with the reduction gear part (200) formed on an outer peripheral surface, a slip shaft (320) of which one side portion is inserted into the first coupling groove (311) formed in the slip housing (310), a slip rubber (340) fixedly installed between the slip shaft (320) and an inner surface of the first coupling groove (311), a slip bush (330) of which one side portion is withdrawn from and inserted into the second coupling groove (312) so as to be selectively assembled and separated from the one side portion of the slip shaft (320) that is inserted through the first coupling groove (311) in which the slip rubber (340) is installed, using a keyway method, and a housing (400) that maintains the slip housing (310) and the reduction gear part (200) in a state of being installed so as to interlock with each other, in a state in which the other side portion of the slip bush (330) and the other side portion of the slip shaft (320) are withdrawn to the outside.

### TECHNICAL FIELD

The present invention relates an actuator for an electric air vent in an automobile, and more particularly, to an actuator for an electric air vent in an automobile, which prevents a gear part and a motor from being deformed or damaged by an external force applied to an operating knob even when an external force is applied to the operating knob.

### BACKGROUND TECHNOLOGY

In general, air vents that discharge air into the interior by the operation of an automobile air conditioning system include center air vents mounted on the center fascia panel between the front of the driver's seat and the front of the passenger's seat, and side air vents mounted on the crash pads on the front of the driver's seat and the front of the passenger's seat.

These air vents are mounted on the center fascia panel or crash pads and are equipped with multiple horizontal and vertical wings and an operating knob to operate them.

However, conventional air vents had a problem in that the wind direction could only be adjusted by the driver manually operating the control knob adjusting horizontal wings mounted at the outlet of the air duct for up-and-down wind direction control and vertical wings positioned at the rear of the horizontal wings for left-right wind direction control.

Accordingly, in order to solve the conventional problems above, an electric air vent has been developed and used in which, when the driving motor is driven in the forward or reverse direction by the operation of a switch, the horizontal wings and the vertical wings rotate in one or the other direction to adjust the wind direction as the driving power of the motor is transmitted through a gear.

However, in the case of actuators used in conventional electric air vents, there was a problem in that when a passenger in a car holds the operating knob with his or her hand and applies external force to manually control the wind direction, the gear part and motor become deformed and damaged by the external force applied through the operating knob, resulting in high replacement and repair costs, and thus high maintenance costs.

### BACKGROUND ART

Korean Patent Application No. 10-2018-0092227.

### DETAILED DESCRIPTION OF THE INVENTION

### Problem to Be Solved

The purpose of the present invention is to solve the above-mentioned conventional problems, and the purpose of the present invention is to provide an actuator for an electric air vent in an automobile, which prevents a gear part and a motor from being deformed or damaged by an external force applied to an operating knob even when a person in an automobile applies an external force to manually control the wind direction while holding the operating knob with his or her hand.

### Means for Solving the Problem

The purposes are achieved by an actuator for an electric air vent in an automobile, the actuator comprising: a reversible motor (100) that generates a driving force to continuously rotate a shaft (600) in a forward/reverse direction in response to a signal outputted from a control device (500); an input gear (110) formed in one direction and the other direction according to the rotation direction of the shaft (600) which rotates according to the driving force generated by the reversible motor (100); a reduction gear part (200) that receives rotational force transmitted through the input gear (110) and is formed to rotate in one direction and the other depending on the rotation direction of the shaft (600); and a slip gear part (300) that receives rotational force transmitted through the reduction gear part (200) and rotates in one direction and the other direction, wherein the slip gear part (300) comprises a slip housing (310) in which a first coupling groove (311) and a second coupling groove (312) are formed on left and right sides so as to communicate, and which has serrated teeth (313) that engage with the reduction gear part (200) formed on an outer peripheral surface, a slip shaft (320) of which one side portion is inserted into the first coupling groove (311) formed in the slip housing (310), a slip rubber (340) fixedly installed between the slip shaft (320) and an inner surface of the first coupling groove (311), a slip bush (330) of which one side portion is withdrawn from and inserted into the second coupling groove (312) so as to be selectively assembled with and separated from the one side portion of the slip shaft (320), that is inserted through the first coupling groove (311) in which the slip rubber (340) is installed, by means of a keyway method, and a housing (400) that maintains the slip housing (310) and the reduction gear part (200) installed in a mutually interlocked state in which the one side portion of the slip bush (330) and the other side portion of the slip shaft (320) are withdrawn to the outside.

Meanwhile, the slip rubber (340) is formed in a corrugated pipe shape, so that a constant state of overlap is maintained between one side outer surface of the slip shaft (320) and an inner wall surface of the first coupling groove (311) of the slip housing (310), thereby effectively generating static friction torque, and also facilitating the work of inserting and coupling the slip shaft (320) into the first coupling groove (311) as minute dimensional changes are absorbed.

Further, a fixed part (321) is formed at the upper and lower portions of one side outer portion of the slip shaft (320) inserted into the first coupling groove (311) to generate a constant frictional torque as an outer surface comes into contact with the slip rubber (340), a variable torque part (322) is formed between the fixed part (321) and the fixed part (321) to generate a variable torque as it expands laterally, and a key (323) is formed at one end of the slip shaft (320), which has the variable torque part (322) and the fixed part (321) formed on its outer portion, so that a slip bush (330) can be easily assembled and disassembled in a keyway manner on one side portion of the slip shaft (320), and at the same time, it is more preferable that the variable torque part (322) expands outward when entering an overlap section, thereby incurring a slip phenomenon and causing the slip shaft to rotate idly.

Meanwhile, the first coupling groove (311) formed in the slip housing (310) into which one side of the slip shaft (320) is inserted and coupled is positioned between the variable torque part (322) and the fixed part (321), such that the outer diameters of the left and right sides are formed smaller than the outer diameters of the upper and lower portions, thereby forming an overlap generation section, so that the variable torque part (322) expands outward when entering the overlap section, thereby incurring a slip phenomenon and causing the slip shaft to rotate idly.

In addition, we would like to make it clear that an insertion groove (331) into which a key is inserted is formed by being dug into the other side of a slip bush (330) that is inserted and coupled into the second coupling groove (312) of the slip housing (310), so that when the slip shaft (320), with its one side portion inserted into the first coupling groove (311) of the slip housing (310), rotates in one direction and the other direction, the slip bush (330) also receives rotational power and rotates in one direction and the other direction at the same time.

### Effects of the Invention

According to the present invention, when a person riding in an automobile applies an external force to manually control a wind direction while holding an operating knob with his/her hand, the slip gear portion causes slipping, thereby preventing the reduction gear part and the motor from being deformed or damaged by the external force applied to the operating knob, thereby making it convenient to repair and maintain vehicles; thus, the present invention is a very useful invention.

### BRIEF DESCRIPTION OF THE DRAWINGS

FIG. 1 is an exploded perspective view showing the configuration of an actuator for an electric air vent in an automobile according to the present invention.

FIG. 2 is a perspective view showing the assembled state of an actuator for an electric air vent in an automobile according to the present invention.

FIG. 3 is a cross-sectional view showing the assembled state of a slip gear part for an actuator of the present invention.

FIG. 4 is a perspective view showing the assembled state of a slip gear part for an actuator of the present invention.

FIG. 5 is an exploded perspective view showing the state of a slip bush being assembled to a slip shaft for an actuator of the present invention.

FIG. 6 is an assembling cross-sectional view showing the state of a slip gear part for an actuator of the present invention being assembled.

FIG. 7 is a perspective view showing the state in which a reduction gear part is engaged to a slip gear part of the present invention.

FIG. 8 is a perspective view showing the state of a slip gear part for an actuator of the present invention with a slip bush disassembled.

FIG. 9 is a sectional view taken along line A-A′ of FIG. 3.

FIG. 10 is an enlarged section view showing a slip rubber mounted on a slip gear part for an actuator of the present invention.

FIG. 11 is a perspective view showing a slip shaft for an actuator of the present invention.

FIG. 12 is a side view showing a slip shaft for an actuator of the present invention.

FIG. 13 is a sectional view taken along line B-B′ of FIG. 12.

### DETAILED DESCRIPTION FOR CARRYING OUT THE INVENTION

Hereinafter, with reference to the attached drawings, embodiments of the present invention will be described in detail so that those with ordinary knowledge in the technical field to which the present invention pertains can easily carry out the invention.

In addition, the present invention may be implemented in forms other than those expressed in the embodiments of the present invention, and is not limited to the embodiments described herein.

It should be noted that the attached drawings are schematic and not drawn to scale.

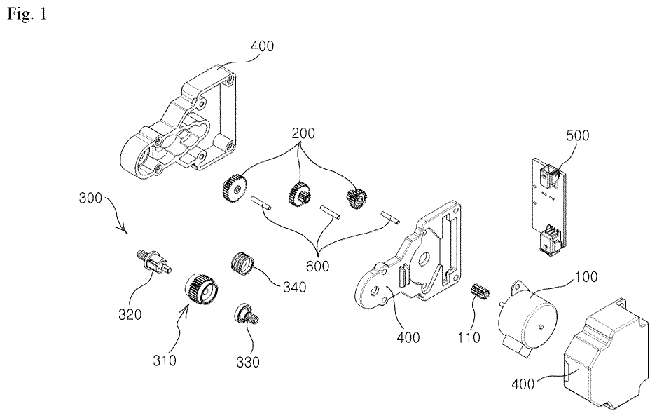

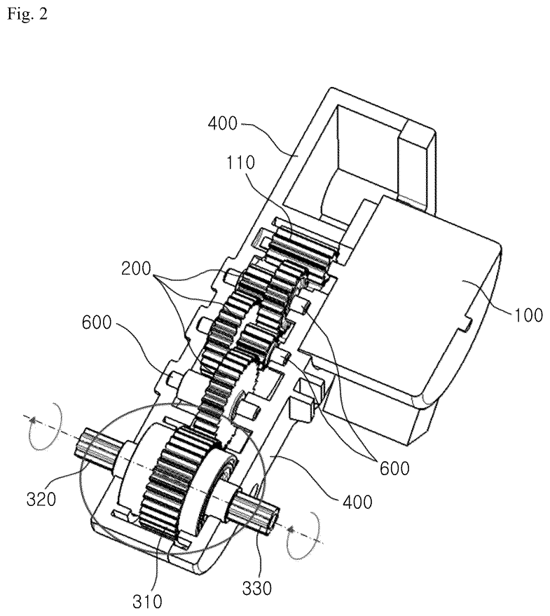

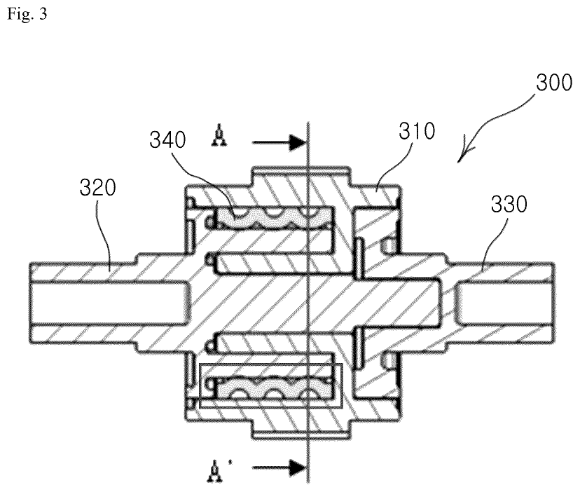

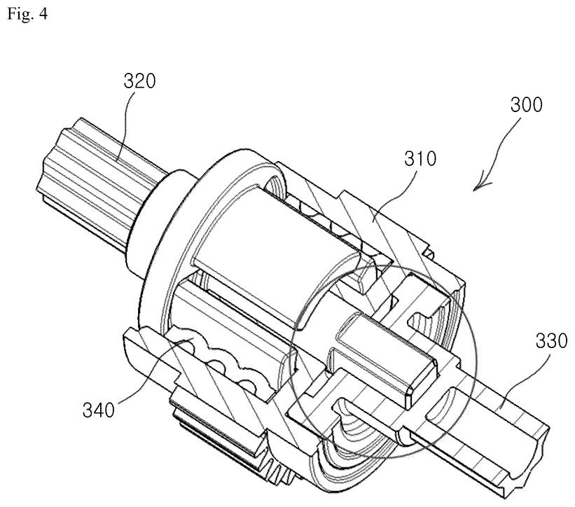

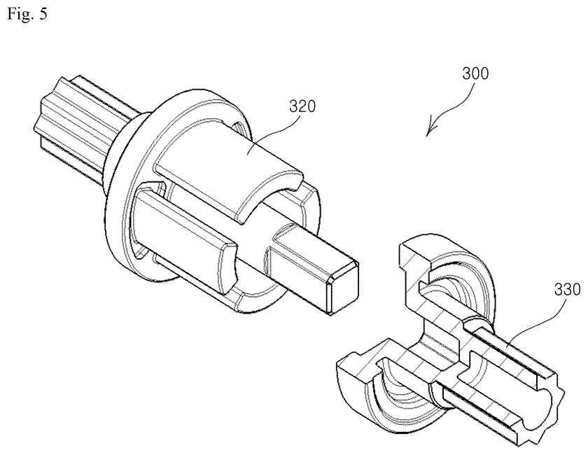

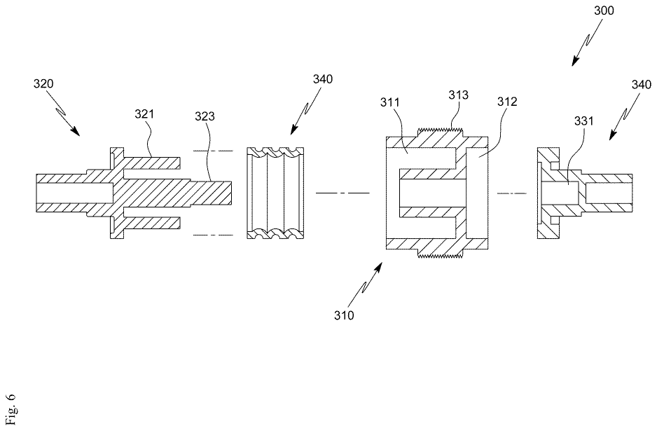

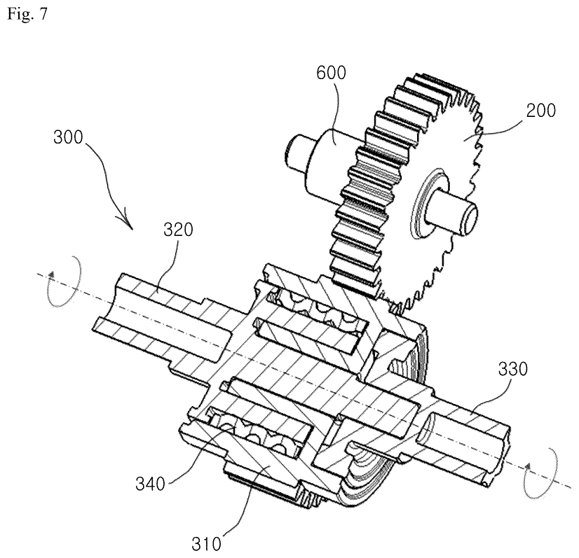

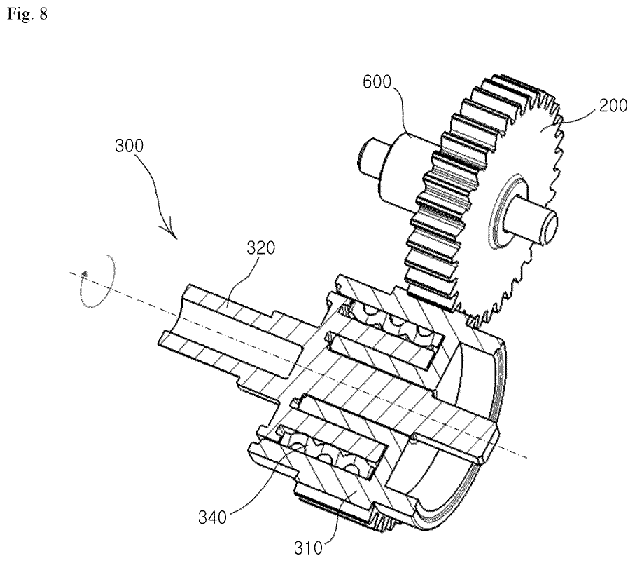

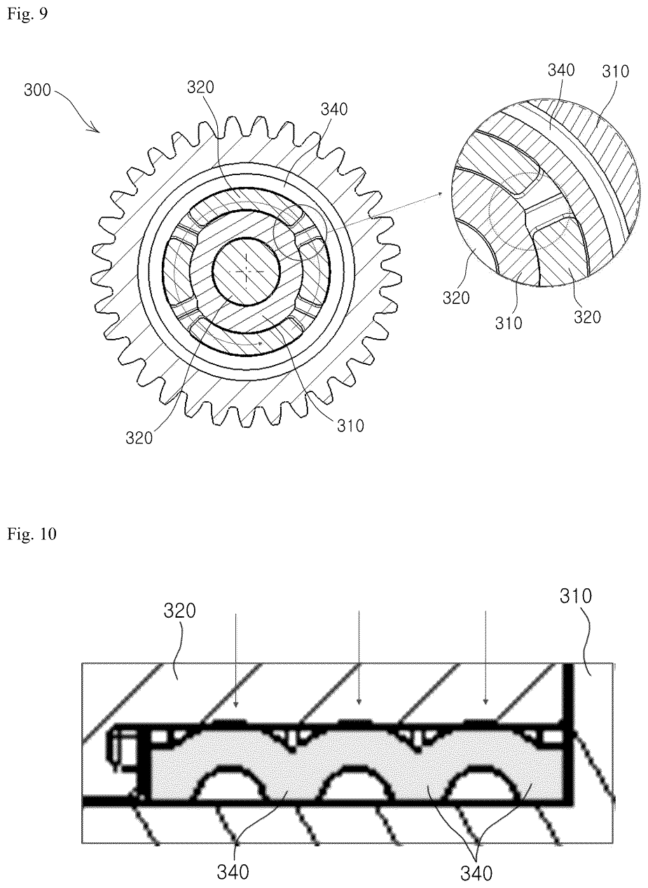

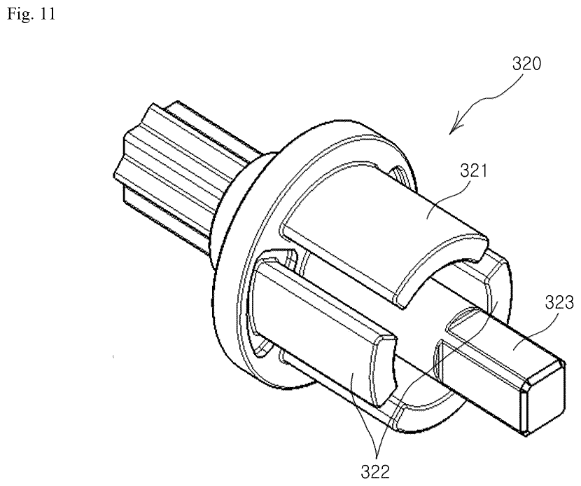

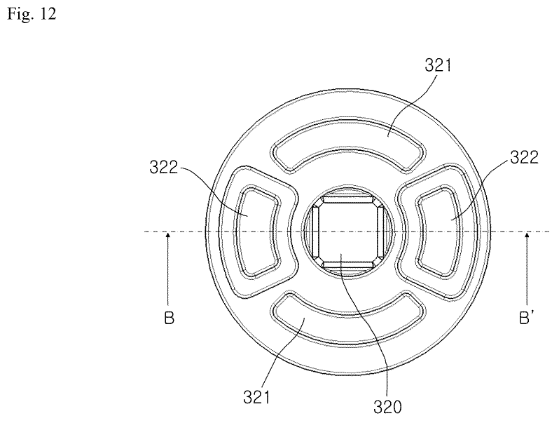

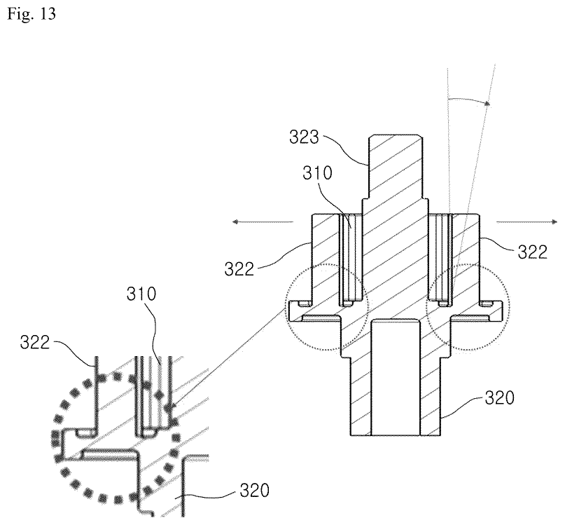

FIG. 1 is an exploded perspective view showing the configuration of an actuator of the present invention for an electric air vent in an automobile. FIG. 2 is a perspective view showing the assembled state of an actuator for an electric air vent in an automobile according to the present invention. FIG. 3 is a cross-sectional view showing the assembled state of a slip gear part for an actuator of the present invention. FIG. 4 is a perspective view showing the assembled state of a slip gear part for an actuator of the present invention. FIG. 5 is an exploded perspective view showing the state of a slip bush being assembled to a slip shaft for an actuator of the present invention. FIG. 6 is an assembling cross-sectional view showing the state of a slip gear part for an actuator of the present invention being assembled. FIG. 7 is a perspective view showing the state in which a reduction gear part is engaged to a slip gear part of the present invention. FIG. 8 is a perspective view showing the state of a slip bush disassembled from a slip gear part for an actuator of the present invention. FIG. 9 is a sectional view taken along line A-A′ of FIG. 3. FIG. 10 is an enlarged section view showing a slip rubber mounted on a slip gear part for an actuator of the present invention. FIG. 11 is a perspective view showing a slip shaft for an actuator of the present invention. FIG. 12 is a side view showing a slip shaft for an actuator of the present invention. FIG. 13 is a sectional view taken along line B-B′ of FIG. 12.

As shown in FIGS. 1 to 13, the actuator for an electric air vent in an automobile according to the present invention comprises a reversible motor (100) that generates a driving force to continuously rotate a shaft (600) in a forward/reverse direction in response to a signal outputted from a control device (500); an input gear (110) formed in one direction and the other direction according to the rotation direction of the shaft (600) which rotates according to the driving force generated by the reversible motor (100); a reduction gear part (200) that receives rotational force transmitted through the input gear (110) and is formed to rotate in one direction and the other depending on the rotation direction of the shaft (600); and a slip gear part (300) that receives rotational force transmitted through the reduction gear part (200) and rotates in one direction and the other direction, wherein the slip gear part (300) comprises a slip housing (310) in which a first coupling groove (311) and a second coupling groove (312) are formed on left and right sides so as to communicate, and which has serrated teeth (313) that engage with the reduction gear part (200) formed on an outer peripheral surface, a slip shaft (320) of which one side portion is inserted into the first coupling groove (311) formed in the slip housing (310), a slip rubber (340) fixedly installed between the slip shaft (320) and an inner surface of the first coupling groove (311), a slip bush (330) of which one side portion is withdrawn from and inserted into the second coupling groove (312) so as to be selectively assembled with and separated from the one side portion of the slip shaft (320), that is inserted through the first coupling groove (311) in which the slip rubber (340) is installed, by means of a keyway method, and a housing (400) that maintains the slip housing (310) and the reduction gear part (200) installed in a mutually interlocked state in which the one side portion of the slip bush (330) and the other side portion of the slip shaft (320) are withdrawn to the outside.

Meanwhile, the slip rubber (340) is formed in a corrugated pipe shape.

In addition, a fixed part (321) is formed at the upper and lower portions of one side outer portion of the slip shaft (320) inserted into the first coupling groove (311) to generate a constant frictional torque as an outer surface comes into contact with the slip rubber (340), a variable torque part (322) is formed between the fixed part (321) and the fixed part (321) to generate a variable torque as it expands laterally, and a key (323) is formed at one end of the slip shaft (320), which has variable torque part (322) and the fixed part (321) on its outer portion.

Meanwhile, the first coupling groove (311) formed in the slip housing (310) into which one side portion of the slip shaft (320) is inserted and coupled is positioned between the variable torque part (322) and the fixed part (321), such that the outer diameters of the left and right sides are formed smaller than the outer diameters of the upper and lower portions, thereby forming an overlap generation section.

Further, an insertion groove (331) into which a key is inserted is formed by being dug into the other side of a slip bush (330) that is inserted and coupled into the second coupling groove (312) of the slip housing (310).

According to the present invention configured as described above, an input gear (110) is coupled to a shaft (600) that rotates in one direction and the other direction by the driving force of a reversible motor (100) in the forward and reverse directions by a signal output from a control device (500). The input gear (110) is engaged with one side gear forming a reduction gear part (200) that is installed in a housing (400) so as to be rotatable around the shaft (600), and serrated teeth (313) formed on an outer peripheral surface of a slip housing (310) forming a slip gear part (300) are engaged with the other side gear forming the reduction gear part (200).

Meanwhile, a slip rubber (340) formed in a corrugated pipe shape is fitted into the first coupling groove (311) formed in the slip housing (310), and one side portion of the slip shaft (320) is inserted and coupled so as to be positioned in the second coupling groove (312), and in order that the other side portion can be selectively assembled in a keyway method on the one side portion of the slip shaft (320) that is inserted and connected so as to be positioned in the second coupling groove (312), the other side portion of the slip bush (330) is inserted into the second coupling groove (312), thereby simultaneously transmitting the driving force of the motor (100).

Of course, if the slip bush (330) is not inserted and connected so as to be positioned in the second coupling groove (312), the driving force of the reversible motor (100) is transmitted to the slip shaft (320) only.

Accordingly, depending on the driving force generated from the reversible motor (100), the slip shaft (320) or the slip bush (330) receives the driving force and rotates in one direction and the other direction.

Meanwhile, when an external force is applied to the slip shaft (320) or slip bush (330), the slip shaft or slip bush (330) rotates in the direction in which the external force is applied, and the slip shaft (320) causes idling and slipping due to an overlap generation section located between the variable torque part (322) formed in the first coupling groove (311) of the slip housing (310) and the fixed part (321), thereby preventing the reduction gear part (200) and the reversible motor (100) from being damaged by the external force applied to the slip shaft (320′) or the slip bush (330).

It should be understood that the embodiments described above are illustrative in all respects and not restrictive, and the scope of the present invention described in the above detailed description is indicated by the claims that follow, and all changes or modifications derived from the meaning and scope of the claims and their equivalent concepts should be interpreted as being included in the scope of the present invention.

### EXPLANATION OF THE REFERENCE NUMBERS

100: reversible motor
110: input gear
200: reduction gear part
300: slip gear part
310: slip housing
311: first coupling groove
312: second coupling groove
313: teeth
320: slip shaft
330: slip bush
340: slip rubber
400: housing
500: control device
600: shaft

1. An actuator for an electric air vent in an automobile, comprising:
a reversible motor (100) that generates a driving force to continuously rotate a shaft (600) in a forward/reverse direction in response to a signal outputted from a control device (500);
an input gear (110) formed in one direction and the other direction according to the rotation direction of the shaft (600) which rotates according to the driving force generated by the reversible motor (100);
a reduction gear part (200) that receives rotational force transmitted through the input gear (110) and is formed to rotate in one direction and the other depending on the rotation direction of the shaft (600); and
a slip gear part (300) that receives rotational force transmitted through the reduction gear part (200) and rotates in one direction and the other direction,
wherein the slip gear part (300) comprises
a slip housing (310) in which a first coupling groove (311) and a second coupling groove (312) are formed on left and right sides so as to communicate, and which has serrated teeth (313) that engage with the reduction gear part (200) formed on an outer peripheral surface,
a slip shaft (320) of which one side portion is inserted into the first coupling groove (311) formed in the slip housing (310),
a slip rubber (340) fixedly installed between the slip shaft (320) and an inner surface of the first coupling groove (311),
a slip bush (330) of which one side portion is withdrawn from and inserted into the second coupling groove (312) so as to be selectively assembled with and separated from the one side portion of the slip shaft (320), that is inserted through the first coupling groove (311) in which the slip rubber (340) is installed, by means of a keyway method, and
a housing (400) that maintains the slip housing (310) and the reduction gear part (200) installed in a mutually interlocked state in which the one side portion of the slip bush (330) and the other side portion of the slip shaft (320) are withdrawn to the outside.

2. An actuator for an electric air vent in an automobile according to claim 1, characterized in that the slip rubber (340) is formed in a corrugated pipe shape.

3. An actuator for an electric air vent in an automobile according to claim 1, characterized in that a fixed part (321) is formed at the upper and lower portions of one side outer portion of the slip shaft (320) inserted into the first coupling groove (311) to generate a constant frictional torque as an outer surface comes into contact with the slip rubber (340), a variable torque part (322) is formed between the fixed part (321) and the fixed part (321) to generate a variable torque as it expands laterally, and a key (323) is formed at one end of the slip shaft (320), which has variable torque part (322) and the fixed part (321) on its outer portion.

4. An actuator for an electric air vent in an automobile according to claim 1, characterized in that the first coupling groove (311) formed in the slip housing (310) into which one side portion of the slip shaft (320) is inserted and coupled is positioned between the variable torque part (322) and the fixed part (321), such that the outer diameters of the left and right sides are formed smaller than the outer diameters of the upper and lower portions, thereby forming an overlap generation section.

5. An actuator for an electric air vent in an automobile according to claim 1, characterized in that an insertion groove (331) into which a key is inserted is formed by being dug into the other side of a slip bush (330) that is inserted and coupled into the second coupling groove (312) of the slip housing (310).
